(19) United States
(12) Patent Application Publication
(10) Pub. No.: US 2006/0210305 A1
(43) Pub. Date: Sep. 21, 2006

(54) Method and apparatus for image forming capable of effectively positioning a supporting member

(75) Inventors: Junichi Murano, Saitama (JP); Kazuyoshi Matsumoto, Tokyo (JP)

Correspondence Address: HARNESS, DICKEY & PIERCE, P.L.C., P.O. BOX 8910, RESTON, VA, 20195, US

(73) Assignee: Ricoh Co., Ltd.

(21) Appl. No.: 11/376,226

(22) Filed: Mar. 16, 2006

(30) Foreign Application Priority Data
Mar. 17, 2005 (JP) 2005-077128

(51) Int. Cl. G03G 15/00

(52) U.S. Cl. 399/117

(57) ABSTRACT

An image forming apparatus includes an image bearing member configured to bear an image on a surface thereof, an image bearing member supporting member configured to support the image bearing member, a sliding member having a guide portion, a positioning member configured to be detachably positioned at a given position on the sliding member and including a fitting portion that has planes and that is configured to fit with image bearing member supporting member while the positioning member being positioned at the given position, and a pressing member configured to press the image bearing member supporting member toward the planes of the fitting portion and having the pressing member having a V-shaped portion so that the V-shaped portion is pushed between the guide portion and the image bearing member supporting member to press the image bearing member supporting member.

### PRIORITY STATEMENT

The present patent application claims priority under 35 U.S.C. §1.119 upon Japanese patent application no. 2005-077128, filed in the Japan Patent Office on Mar. 17, 2005, the disclosure of which is incorporated by reference herein in its entirety.

### BACKGROUND

It is well known that a conventional image forming apparatus including an electrophotographic copier, printer, facsimile machine, multi-functional machine and so forth has a technique that can position an image bearing member supporting member.

In the image forming apparatus having the above-described technique, it is necessary to properly position and mount the image bearing member with respect to a main body of the image forming apparatus to form a high quality image on an image bearing member.

Therefore, a conventional image forming apparatus has a structure, for example as disclosed in Japanese Laid-open Patent Application Publication No. 2004-233902, that includes a positioning member that is positioned and mounted to a mounting position with respect to a frame of the main body of the image forming apparatus. When the positioning member is mounted on the mounting position, an image bearing member supporting member is fitted into the mounting hole formed on the positioning member to position the image bearing member supporting member. Thereby, the image bearing member can be properly positioned on the main body of the image forming apparatus.

In this case, however, the amount of rotation speed deviation element drive gear during maintenance and/or replacement of the photoconductive element. The mounting hole is used as a tooling hole or a fitting portion for the image bearing member supporting member.

In the above-described conventional image forming apparatus, however, the image bearing member supporting member is fitted into the mounting hole of the positioning member to position the image bearing member supporting member with respect to the positioning member. That is, the mounting hole does not have a great amount of play, which makes it difficult to fit the image bearing member supporting member into the mounting hole, and the image forming apparatus has a disadvantage in the operability of positioning the image bearing member supporting member.

### SUMMARY OF THE INVENTION

One or more embodiments of the present invention have arisen in view of the above-mentioned circumstances.

One or more embodiments of the present invention provide an image forming apparatus that can effectively position an image bearing member supporting member to a positioning member mounted on the image forming apparatus.

One or more embodiments of the present invention provide a method of positioning the image bearing member supporting member properly to the above-described image forming apparatus.

An embodiment of the present invention provides an image forming apparatus that includes an image bearing member, an image bearing member supporting member, a sliding member, a positioning member, and a pressing member. The image bearing member is configured to bear an image on a surface thereof. The image bearing member supporting member is configured to support the image bearing member. The sliding member has a guide portion. The positioning member is configured to be detachably positioned at a given position on the sliding member. The positioning member includes a fitting portion having planes and configured to fit with image bearing member supporting member while the positioning member being positioned at the given position. The pressing member is configured to press the image bearing member supporting member toward the planes of the fitting portion. The pressing member has a V-shaped portion so that the V-shaped portion is pushed between the guide portion and the image bearing member supporting member to press the image bearing member supporting member.

An embodiment of the present invention provides such an image forming apparatus in which the sliding member may be configured to move between first and second positions and that further includes a regulating member mounted thereon configured to regulate a movement of the pressing member. The pressing member may be movably supported by the positioning member while biased by a spring, both ends of which are locked by the sliding member and the pressing member.

When the sliding member is located at the first position, the pressing member biased by the spring may be regulated by the regulating member to stay away from the image bearing member supporting member.

When the sliding member leaves from the first position for the second position, the pressing member may move together with the sliding member.

When the sliding member comes to a third position located between the first and the second positions, the V-shaped portion may be pushed to a position between the guide portion and the image bearing member supporting member, and then is stopped.

When the sliding member further moves toward the second position, the pressing member may be released from a force exerted by the regulating member.

An embodiment of the present invention provides a method for positioning an image bearing member supporting member, the method including the steps of mounting the image bearing member supporting member to an image forming apparatus, closing a cover of the image forming apparatus to fit the image bearing member supporting member into a fitting hole formed on a positioning member mounted with respect to the cover, moving a sliding member in a given direction, contacting a pressing member mounted on the sliding member with the image bearing member supporting member, moving the sliding member to a given position, pushing a V-shaped portion of the pressing member between a guide portion of the sliding member and the image bearing member supporting member to press the image bearing member supporting member, and engaging the image bearing member supporting member with the positioning member.

Additional features and advantages of the present invention will be more fully apparent from the following detailed description of example embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic structure of an image forming apparatus according to an example embodiment of the present invention;

FIG. 2 is a cross sectional view (according to an example embodiment of the present invention) of a process cartridge of the image forming apparatus of FIG. 1;

FIG. 3 is a perspective view (according to an example embodiment of the present invention) of a schematic structure of a frame of a main body of the image forming apparatus, process cartridges mounted to the image forming apparatus, and a positioning member on the image forming apparatus;

FIG. 4 is a front elevational view (according to an example embodiment of the present invention) of the positioning member and a sliding member at its first position;

FIG. 5 is a front elevational view of the positioning member and the sliding member of FIG. 4 at its second position;

FIG. 6 is a exploded perspective view (according to an example embodiment of the present invention) of the sliding member, the positioning member, and the process cartridge; and

FIG. 7 is a perspective view (according to an example embodiment of the present invention) of the positioning member and the sliding member, viewed from an inside of the main body of the image forming apparatus.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, example embodiments of the present patent application are described.

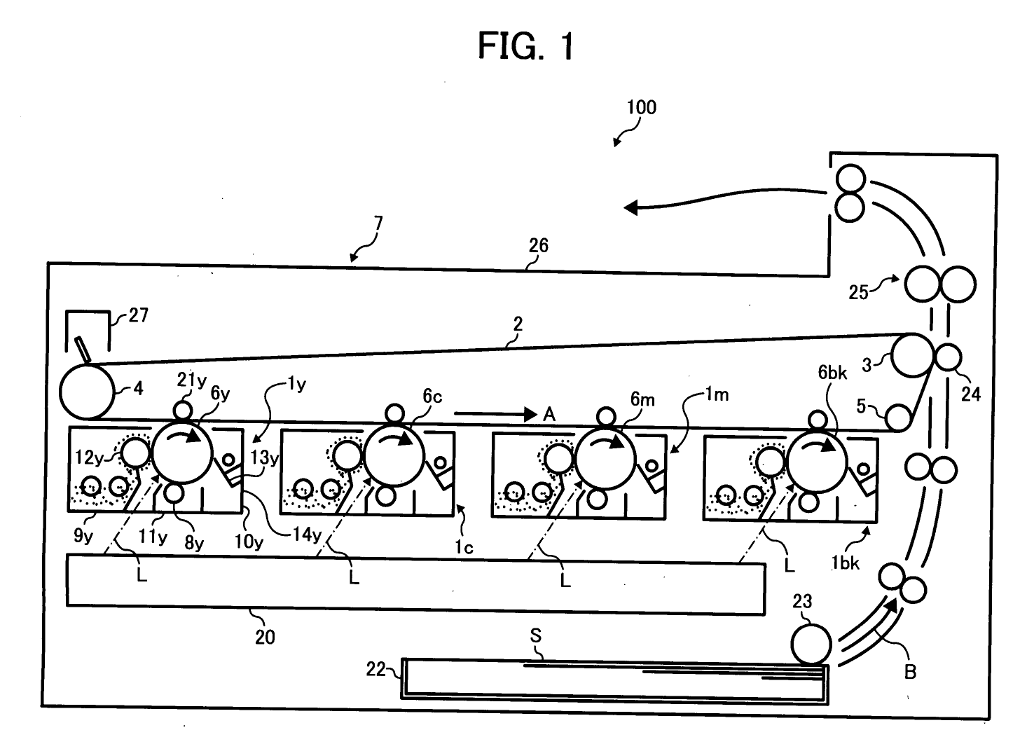

Referring to FIGS. 1, 2, and 3, a schematic structure of an image forming apparatus 100 is described according to one or more example embodiments of the present invention.

In FIG. 1, the image forming apparatus 100 includes a main body 7, a plurality of process cartridges of 1y, 1c, 1m, and 1bk, and an intermediate transfer belt 2.

The plurality of process cartridges 1y, 1c, 1m, and 1bk are disposed in the main body 7 of the image forming apparatus 1.

The intermediate transfer belt 2 is disposed opposite to the plurality of process cartridges 1y, 1c, 1m, and 1bk. The intermediate transfer belt 2 forms an endless belt extending over a plurality of supporting rollers 3, 4, and 5.

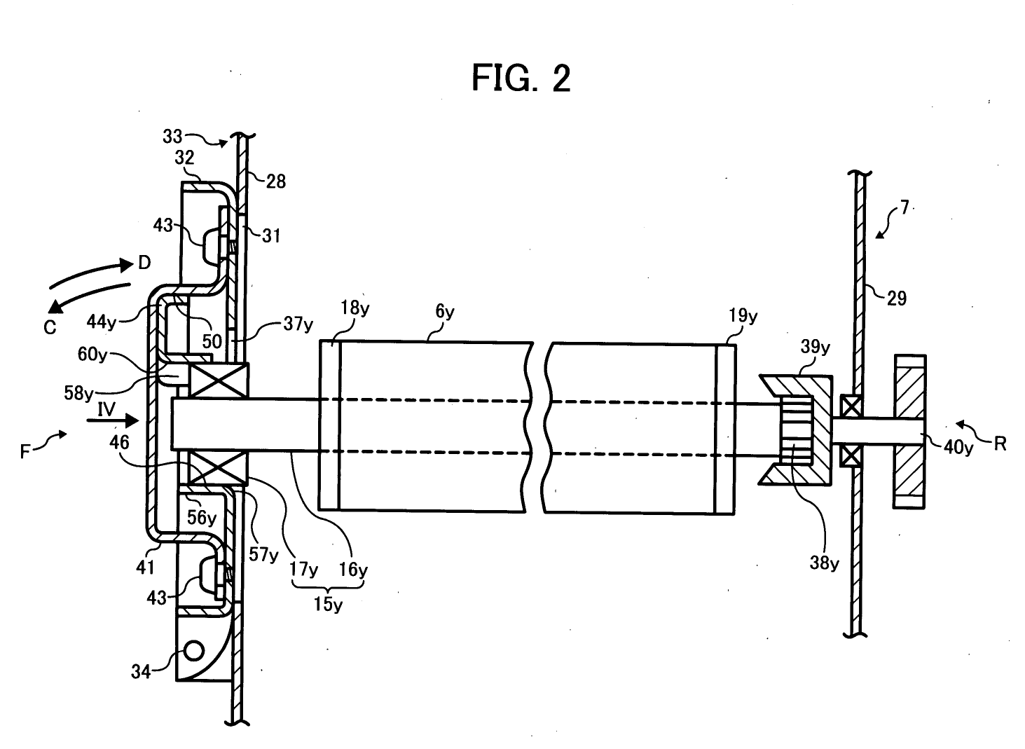

The plurality of process cartridges 1y, 1c, 1m, and 1bk include a plurality of respective image bearing members 6y, 6c, 6m, and 6bk serving as a drum-shaped photoconductive element, and perform image forming operations for producing respective toner images with toners of different colors of yellow (y), magenta (m), cyan (c), and black (bk). Each of the toner images are transferred onto the intermediate transfer belt 2. Since the above described components indicated by y, c, m, and bk used for the image forming operations have similar structures and functions, except that respective toner images formed thereon are of different colors, which are yellow, magenta, cyan, and black toners, the discussion in FIG. 2 uses reference numerals for specifying components of the color image forming apparatus 100 with the suffix of color of “y”.

The process cartridge 1y includes the image bearing member 6y and other image forming components arranged around the image bearing member 6y, for example, a charging unit 11y having a charging roller 8y, a developing unit 9y having a developing roller 12y, and a cleaning unit 10y having a cleaning blade 13y. The developing unit 9y, the cleaning unit 10y, and a charging unit 11y are included in a unit case 14y.

FIG. 2 shows a schematic structure of the process cartridge 1y, focusing on a structure around the image bearing member 6y. The process cartridge 1y further include a supporting member 15y that supports the image bearing member 6y. Other components and parts of the process cartridge 1y are not shown in FIG. 2. The supporting member 15y includes a supporting shaft 16y and a bearing 17y. The supporting shaft 16y supports the image bearing member 6y. The bearing 17y, for example a ball bearing, is mounted on the supporting shaft 16y. The image bearing member 6y has flanges 18y and 19y at both ends, and is fixedly supported to the supporting shaft 16y via the flanges 18y and 19y. The supporting shaft 16y is rotatably mounted via a bearing (not shown) to the unit case 14y shown in FIG. 1.

When a series of image forming operations starts, the image bearing member 6y is driven to rotate by a motor (not shown) in a clockwise direction in FIG. 1, and the intermediate transfer belt 2 is driven to rotate by a motor (not shown) in a direction as indicated by arrow A. At this time, the charging roller 8y of the charging unit 11y is rotated while contacting a surface of image bearing member 6y, thereby the image bearing member 6y is charged to an appropriate polarity. The image forming apparatus 100 further includes an optical writing unit 20 as shown in FIG. 1. The optical writing unit 20 emits a laser beam L that is deflected in the optical writing unit 20 to irradiate a surface of the charged image bearing member 6y so that an electrostatic latent image can be formed on the surface of the image bearing member 6y.

The developing roller 12y of the developing unit 9y is driven to rotate by a motor (not shown) in a counterclockwise direction in FIG. 1. The developing roller 12y bears and coveys dry developer on its surface. Yellow toner in the dry developer conveyed by the developing roller 12y is statically transferred onto the electrostatic latent image formed on the surface of the image bearing member 6y, thereby the electrostatic latent image turns to a yellow toner image. A primary transfer roller 21y is disposed opposite to the process cartridge 1, sandwiching the intermediate transfer belt 2. The primary transfer roller 21y forms a primary transfer nip between the image bearing member 6y and the primary transfer roller 21y so that the yellow toner image formed on the surface of the image bearing member 6y is transferred onto the intermediate transfer belt 2. Residual toner adhering on the surface of the image bearing member 6y remaining after the yellow toner image is transferred is removed from the surface of the image bearing member 6y by the cleaning blade 13y of the cleaning unit 10y.

The similar image forming operations as described above are performed for the process cartridges 1c, 1m, and 1bk. That is, a cyan toner image, a magenta toner image, and a black toner image are formed on the respective image bearing members 6c, 6m, and 6bk, and the cyan, magenta, and black toner images are sequentially laid on the yellow toner image transferred on the intermediate transfer belt 2.

The image forming apparatus 100 further includes a sheet feeding cassette 22 having a sheet feeding roller 23. The sheet feeding cassette 22 is disposed below the main body 7 of the image forming apparatus 100 as shown in FIG. 1. The sheet feeding cassette 22 holds a stack of recording media including a recording medium S placed on the top of the recording media. The sheet feeding roller 23 is rotated to feed the recording medium S in a direction as indicated by arrow B. The recording medium S is fed from the sheet feeding cassette 22, and is conveyed to a position between the intermediate transfer belt 2 and a secondary transfer roller 24 disposed opposite to the intermediate transfer belt 2. A secondary transfer nip is formed between the supporting roller 3 and the secondary transfer roller 24 so that the overlaid toner image formed on intermediate transfer belt 2 is transferred onto the recording medium S. The recording medium S having the overlaid toner image thereon is further conveyed upwardly to a fixing unit 25. The fixing unit 25 fixes the overlaid toner image by heat and pressure.

After passing the fixing unit 25, the recording medium S is discharged to a sheet discharging part 26 formed on top of the main body 7 of the image forming apparatus 100.

Further, residual toner remaining on the intermediate transfer belt 2 after the transfer of the overlaid toner image is removed by a belt cleaning unit 27.

In FIG. 2, the reference number “F” indicates a front side or a near side of the image forming apparatus 100, and the reference number “R” indicates a far side or a rear side of the image forming apparatus 100. The process cartridges 1y, 1c, 1m, and 1bk are detachably disposed in the main body 7 of the image forming apparatus 100. Details of the structure of the main body 7 will be described later.

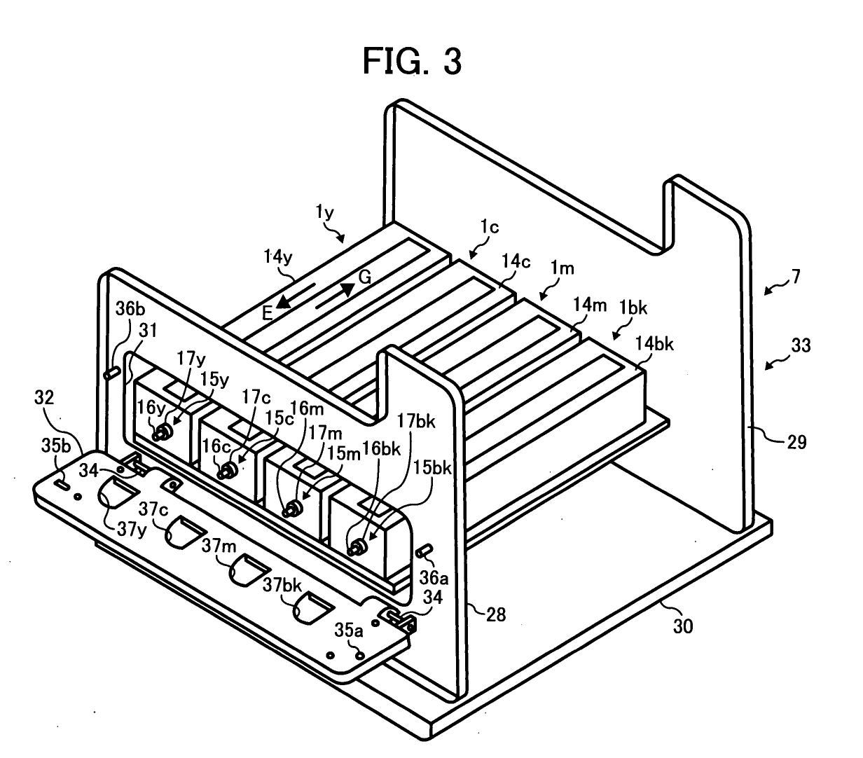

The image forming apparatus 100 further includes a frame 33 in the main body 7. The frame 33 includes a front side plate 28 and a rear side plate 29, both of which are shown in FIGS. 2 and 3, and a bottom plate 30 shown in FIG. 3. The front side plate 28 is disposed at the near side of the image forming apparatus 100, and rear side plate 29 is disposed at the far side of the image forming apparatus 100. The front and rear side plates 28 and 29 are fixedly attached to the bottom plate 30. The front side plate 28 includes an opening 31 that is regularly covered by a positioning member 32 as shown in FIG. 2. The image forming apparatus further includes an outer cover (not shown) and a front cover (not shown), both of which are disposed around the frame 33 and the positioning member 32.

In FIG. 3, the process cartridges 1c, 1m, and 1bk have unit cases 14c, 14m, and 14bk, respectively. The process cartridges 1c, 1m, and 1bk also have supporting members 15c, 15m, and 15bk, respectively, to support the image bearing members 6c, 6m, and 6bk, respectively. The supporting members 15c, 15m, and 15bk have supporting shafts 16c, 16m, and 16bk, respectively, and bearings 17c, 17m, and 17bk, respectively. The supporting shafts 16c, 16m, and 16bk supports the image bearing members 6c, 6m, and 6bk of the process cartridges 1c, 1m, and 1bk. The bearings 17c, 17m, and 17bk are mounted on the near side of the supporting shafts 16c, 16m, and 16bk, respectively.

As shown in FIGS. 2 and 3, the positioning member 32 is mounted with respect to the front side plate 28 via a pair of hinge pins 34. The positioning member 32 is rotatable in directions as indicated by arrows C and D in FIG. 2. FIG. 2 shows the positioning member 32 at its closed position. When the positioning member 32 is at the closed position, a positioning hole 35a formed on the positioning member 32 is engaged with a positioning pin 36a fixedly protruded on the front side plate 28 and a positioning hole 35b formed on the positioning member 32 is engaged with a positioning pin 36b fixedly protruded on the front side plate 28. Thus, the positioning member 32 is positioned by being engaged with the frame 33 of the main body 7 of the image forming apparatus 100. The closed position of the positioning member 32 is also identified as a mounting position of the positioning member 32 with respect to the frame 33 of the image forming apparatus 100. Thus, the positioning member 32 is detachably mounted on the image forming apparatus 100 by being positioned at the mounting position with respect to the frame 33 of the main body 7 of the image forming apparatus 100.

Further, as shown in FIG. 3, the positioning member 32 includes mounting holes 37y, 37c, 37m, and 37bk serving as a fitting portion. When the positioning member 32 is closed as shown in FIG. 2, that is, when the positioning member 32 is at the mounting position, the bearings 17y, 17c, 17m, and 17bk are received into the mounting holes 37y, 37c, 37m, and 37bk, respectively, of the supporting member 15ym 15c, 15m, and 15bk, respectively. By fitting the bearings 17y, 17c, 17m, and 17bk into the mounting holes 37y, 37c, 37m, and 37bk, respectively, the near side of the supporting members 15y, 15c, 15m, and 15bk are positioned with respect to the positioning member 32. Thus, the mounting holes 37y, 37c, 37m, and 37bk formed on the positioning member 32 are utilized to fit with the supporting members 15y, 15c, 15m, and 15bk while the positioning member 32 is disposed in the mounting position.

On the other hand, as shown in FIG. 2, the supporting shaft 16y has an image bearing member gear 38y fixedly mounted at the end portion of the far side of the supporting shaft 16y. The rear side plate 29 has a cup-shaped gear 39y and its shaft 40y that is rotatably supported thereon. The image bearing member gear 38y is detachably engaged with the cup-shaped gear 39y. With the above-described structure, the end portion of the far side of the supporting shaft 16y is positioned with respect to the rear side plate 29. Baffle pins (not shown) are fixedly protruded at both ends of the near and far sides of the unit case 14y. The baffle pins are engaged with respective holes (not shown) formed at the positioning member 32 and the rear side plate 29 so as to prevent the process cartridge 1y from rotating around the supporting shaft 16y.

The shaft 40y is driven by a motor (not shown) to rotate. The torque of the rotation is transmitted via the image bearing member gear 38y and the cup-shaped gear 39y to the supporting shaft 16y, which rotates the image bearing member 6y as previously described. Since the near side portion of the supporting shaft 16y is fitted into the mounting hole 37y of the positioning member 32 via the bearing 17y, the supporting shaft 16y can be smoothly rotated in the above-described operation.

The similar image forming operations as described above are performed for the process cartridges 1c, 1m, and 1bk. That is, the far side portion of each of supporting shafts 16c, 16m, and 16bk of the process cartridge 1c, 1m, and 1bk are positioned with respect to the rear side plate 29, accordingly. And, the supporting shafts 16c, 16m, and 16bk and the image bearing members 6c, 6m, and 6bk are rotated in a same manner as described above.

While the motors of the image forming apparatus 100 are stopped, when the front door of the image forming apparatus 100 is opened and the positioning member 32 is rotated to an open positioned as shown in FIG. 3 simultaneously, the opening 31 becomes open.

When any of the process cartridges 1y, 1c, 1m, and 1bk is pulled in a direction as indicated by arrow “E” under the above-described condition, the process cartridges 1y, for example, is guided by a guide rail (not shown) to be drawn toward the near side or front side of the image forming apparatus 100.

Conversely, when any of the process cartridges 1y, 1c, 1m, and 1bk is pushed in a direction as indicated by arrow “G” under the above-described condition, the process cartridge 1y, for example, is inserted as guided by the guide rail toward the far side of the image forming apparatus 100. At this time, as shown in FIG. 2, the image bearing member gear 38y is engaged with the cup-shaped gear 39y. Thereby, the far end portion of the supporting shaft 16y is positioned with respect to the frame 33. Then, the positioning member 32 is rotated to the closed position as shown in FIG. 2 so that the positioning member 32 is positioned with respect to the front side plate 28.

Under the above-described condition, the near end portion of the supporting shaft 16y is positioned with respect to the frame 33. By closing the front door, the image forming apparatus 100 can be made ready to start a series of image forming operations. The process cartridges 1c, 1m, and 1bk can be detached and attached to the main body 7 of the image forming apparatus 100 in the same manner as described above.

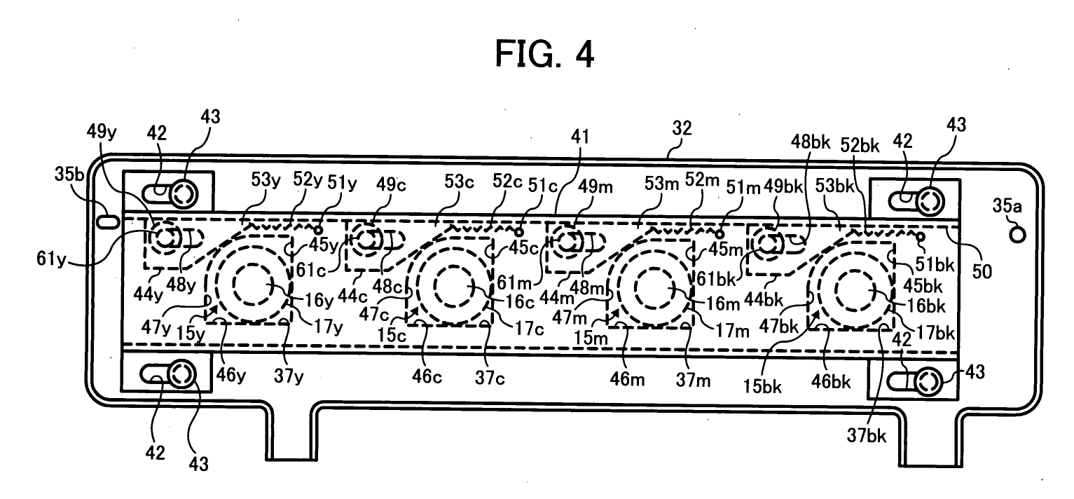

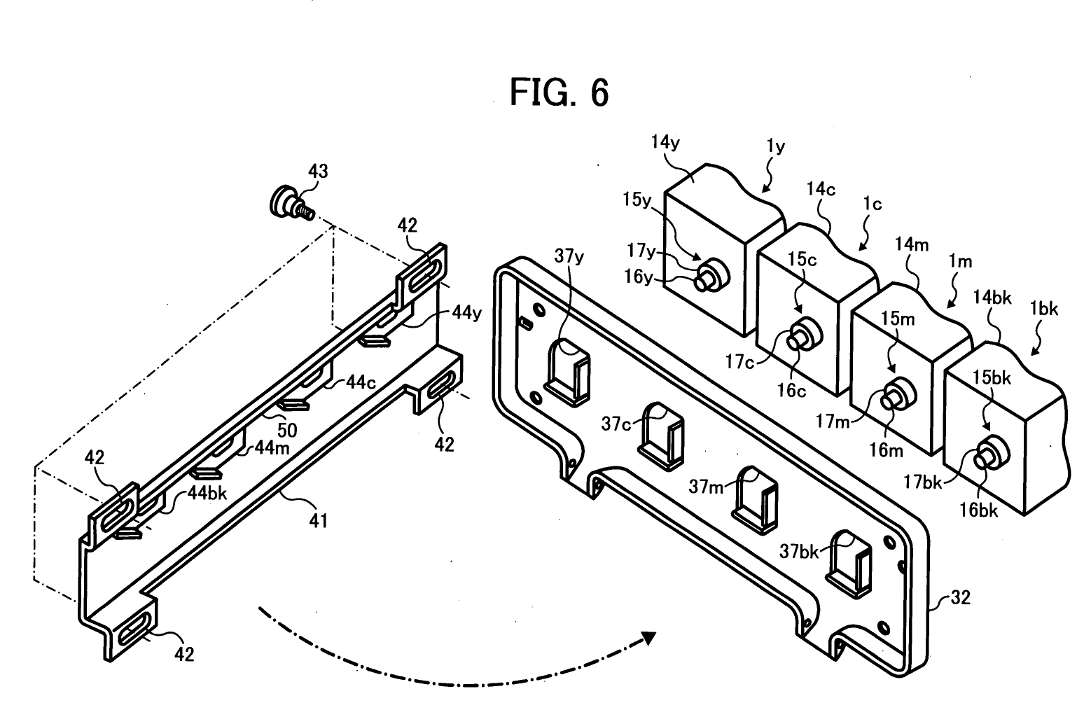

Referring to FIGS. 4, 5, 6, and 7, a detailed structure (according to one or more example embodiments of the present invention) of the main body 7 of the image forming apparatus 100 is described to show how to position the near side of each of the supporting members 15y, 15c, 15m, and 15bk with respect to the frame 33 of the main body 7 of the image forming apparatus 100.

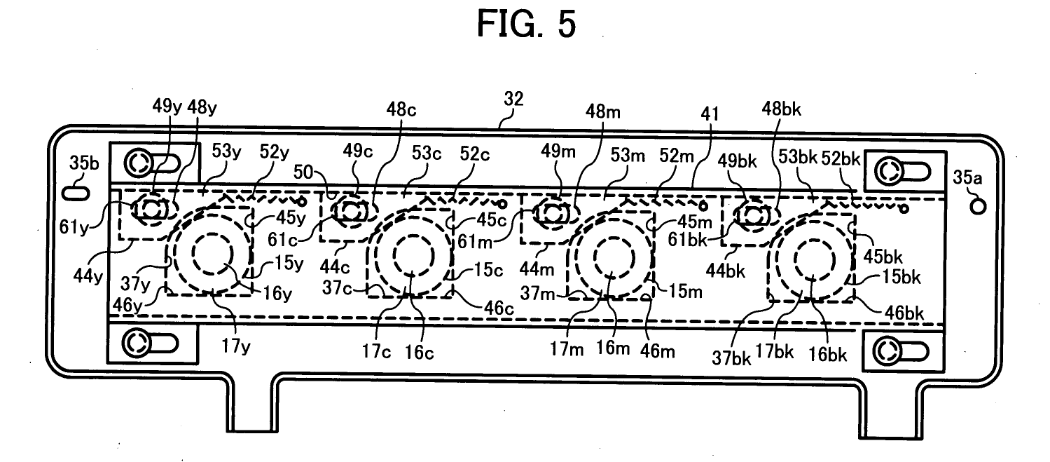

FIG. 4 shows a structure of the main body 7 of the image forming apparatus 100 viewed in a direction indicated by arrow “IV” of FIG. 2. In FIG. 4, the process cartridges 1y, 1c, 1m, and 1bk are pushed to the far side of the main body 7 of the image forming apparatus 100, and the positioning member 32 is rotated to the closed position. The positioning holes 35a and 35b formed on the positioning member 32 are engaged with the positioning pins 36a and 36b on the front side plate 28 so that the positioning member 32 can be positioned at the mounting position. As seen from FIGS. 2, 4, and 6, the positioning member 32 is provided with a sliding member 41 having a plurality of long holes 42 in a horizontal direction. The plurality of long holes 42 are relatively engaged with shoulder screws 43 corresponding to the plurality of long holes 42. The shoulder screws 43 are screwed to the positioning member 32. With the above-described structure, the sliding member 41 is movably supported by the positioning member 32 when the sliding member 41 moves in a horizontal direction between a first position as shown in FIG. 4 and a second position as shown in FIG. 5.

The positioning member 32 in the open position as shown in FIG. 3 is rotated to the closed position as shown in FIG. 4, the bearings 17y, 17c, 17m, and 17bk may be fitted into the mounting holes 37y, 37c, 37m, and 37bk formed on the positioning member 32. At this time, as shown in FIG. 4, each size of the mounting holes 37y, 37c, 37m, and 37bk is larger than a cross sectional area of each of the bearings 17y, 17c, 17m, and 17bk respectively engaged with the respective supporting shafts 16y, 16c, 16m, and 16bk. That is, the bearings 17y, 17c, 17m, and 17bk can be fitted into the mounting holes 37y, 37c, 37m, and 37bk with a great amount of play. Therefore, the bearings 17y, 17c, 17m, and 17bk can easily be fitted into the mounting holes 37y, 37c, 37m, and 37bk.

Further, as shown in FIG. 4, each of the mounting holes 37y, 37c, 37m, and 37bk includes a vertical plane 45, a horizontal plane 46, and a curved plane 47. The vertical plane 45 and the horizontal plane 46 are disposed substantially perpendicular to each other.

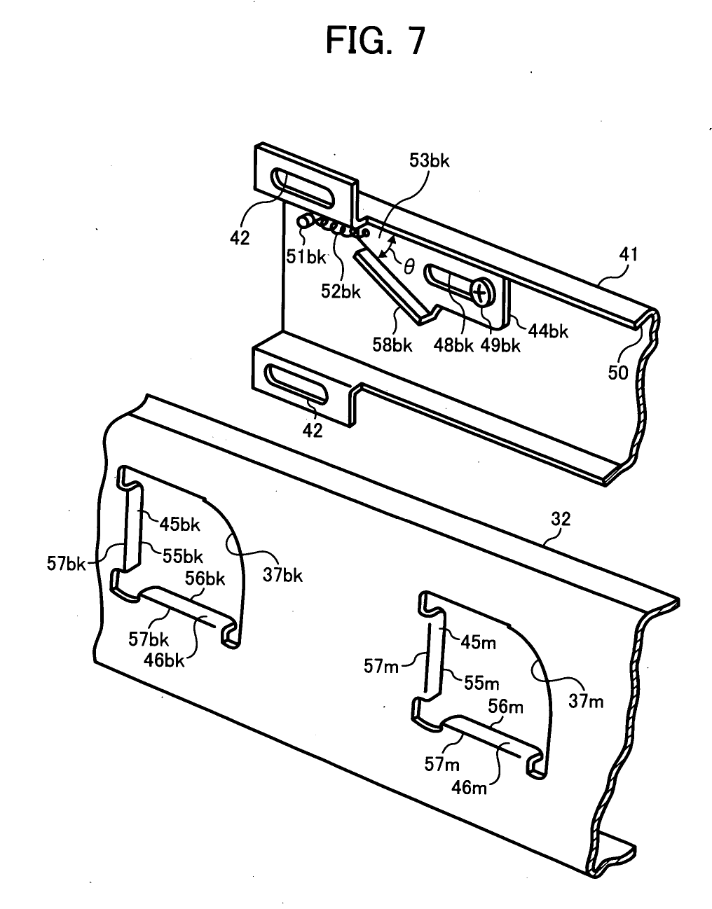

On the other hand, as shown in FIGS. 2, 4, 5, and 6, respective pressing members 44y, 44c, 44m, and 44bk are disposed corresponding to the bearings 17y, 17c, 17m, and 17bk. The pressing members 44y, 44c, 44m, and 44bk have respective V-shaped portions 53y, 53c, 53m, and 53bk that are tapered. For example, the pressing member 44bk having the V-shaped portion 53bk is shown in FIG. 7.

Further, the pressing members 44y, 44c, 44m, and 44bk have respective long holes 48y, 48c, 48m, and 48bk that extend in a substantially horizontal direction. The long holes 48y, 48c, 48m, and 48bk are slidably engaged with stoppers 49y, 49c, 49m, and 49bk, respectively, which are a shoulder screw screwed to the sliding member 41 to regulate a movement of each of the pressing members 44y, 44c, 44m, and 44bk.

With the above-described structure, the pressing members 44y, 44c, 44m, and 44bk can move in a horizontal direction in a given stroke with respect to the sliding member 41.

A lower surface of a flange formed on the upper portion of the sliding member 41 serve as a guide surface 50 that serves as a guide portion guiding the pressing members 44y, 44c, 44m, and 44bk, when the pressing members 44y, 44c, 44m, and 44bk move in a horizontal direction. For the above-described reason, the sliding member 41 has the guide surface 50 for the pressing members 44y, 44c, 44m, and 44bk.

As shown in FIG. 4, tension springs 52y, 52c, 52m, and 52bk are provided to the sliding member 41. One end of the respective tension springs 52y, 52c, 52m, and 52bk is latched at the pressing members 44y, 44c, 44m, and 44bk, respectively, and the other end thereof is respectively latched at the connecting pins 51y, 51c, 51m, and 51bk protruding at the sliding member 41. With the above-described structure, the pressing members 44y, 44c, 44m, and 44bk are biased to the right side of FIG. 4. When the sliding member 41 is located at the first portion thereof as shown in FIG. 4, first end portions 61y, 61c, 61m, and 61bk of the respective long holes 48y, 48c, 48m, and 48bk are held in contact with the stoppers 49y, 49c, 49m, and 49bk, respectively, so that the pressing members 44y, 44c, 44m, and 44bk may stop at the position shown in FIG. 4. At this time, the pressing members 44y, 44c, 44m, and 44bk stay away from the corresponding bearings 17y, 17c, 17m, and 17bk of the supporting members 15y, 15c, 15m, and 15bk.

As described above, the pressing members 44y, 44c, 44m, and 44bk are movably supported by the sliding member 41 while biased by the respective tension springs 52y, 52c, 52m, and 52bk. When the sliding member 41 is located at the first position, the pressing members 44y, 44c, 44m, and 44bk respectively biased by the tension springs 52y, 52c, 52m, and 52bk are regulated by the respective stoppers 49y, 49c, 49m, and 49bk mounted on the sliding member 41 so that the pressing members 44y, 44c, 44m, and 44bk can stay away from the supporting members 15y, 15c, 15m, and 15bk, that is, the pressing members 44y, 44c, 44m, and 44bk can be prevented from contacting the supporting members 15y, 15c, 15m, and 15bk.

With the above-described structure, when an operator manually rotates the positioning member 32 from its open position as shown in FIG. 2 to its closed position as shown in FIG. 4, the bearings 17y, 17c, 17m, and 17bk can be fitted into the mounting holes 37y, 37c, 37m, and 37bk, respectively, without interfering the pressing members 44y, 44c, 44m, and 44bk.

Next, the operator manually slides the sliding member 41 with a rod-like member mounted on the sliding member 41 to the right direction in FIG. 4, to move the sliding member 41 to the second position as shown in FIG. 5. There, the V-shaped portions 53y, 53c, 53m, and 53bk of the respective pressing members 44y, 44c, 44m, and 44bk are pressed to a position between the guide surface 50 and the bearings 17y, 17c, 17m, and 17bk of the respective supporting members 15y, 15c, 15m, and 15bk so that the bearings 17y, 17c, 17m, and 17bk can be pressed toward the respective vertical planes 45y, 45c, 45m, and 45bk and the respective horizontal planes 46y, 46c, 46m, and 46bk formed on the mounting holes 37y, 37c, 37m, and 37bk, respectively.

Detailed operations are described below.

When the operator starts to slide the sliding member 41 from the first position shown in FIG. 4 to the second position in FIG. 5, the pressing members 44y, 44c, 44m, and 44bk biased by the respective tension springs 52y, 52c, 52m, and 52bk and regulated by the respective stoppers 49y, 49c, 49m, and 49bk start to move together with the sliding member 41 to the right direction of FIG. 4. Then, when the sliding member 41 come to a third position located between the first and second positions, the V-shaped portions 53y, 53c, 53m, and 53bk of the pressing members 44y, 44c, 44m, and 44bk biased by the tension springs 52y, 52c, 52m, and 52bk, respectively, are pushed to a position between the guide surface 50 and the bearings 17y, 17c, 17m, and 17bk of the respective supporting members 15y, 15c, 15m, and 15bk, and are stopped by contacting respective circumferential surfaces of the bearings 17y, 17c, 17m, and 17bk.

With the above-described operation, the pressing members 44y, 44c, 44m, and 44bk forcedly press the bearings 17y, 17c, 17m, and 17bk with respect to the vertical planes 45y, 45c, 45m, and 45bk and the horizontal planes 46y, 46c, 46m, and 46bk of the mounting holes 37y, 37c, 37m, and 37bk, respectively.

After the pressing members 44y, 44c, 44m, and 44bk are stopped, the sliding member 41 continuously moves toward the second position, the ends 61y, 61c, 61m, and 61bk of the long holes 48y, 48c, 48m, and 48bk formed on the respective pressing members 44y, 44c, 44m, and 44bk are separated from the stoppers 49y, 49c, 49m, and 49bk so that the pressing members 44y, 44c, 44m, and 44bk can be released from the force exerted by the stoppers 49y, 49c, 49m, and 49bk.

As described above, since the bearings 17y, 17c, 17m, and 17bk press contact with the vertical planes 45y, 45c, 45m, and 45bk and the horizontal planes 46y, 46c, 46m, and 46bk of the mounting hole 37y, 37c, 37m, and 37bk, respectively, the near side portions of the supporting members 15y, 15c, 15m, and 15bk and the image bearing members 6y, 6c, 6m, and 6bk supported by the corresponding supporting members 15y, 15c, 15m, and 15bk are properly positioned to the positioning member 32. At this time, the positioning member 32 is properly positioned with respect to the frame 33. Accordingly, the image bearing members 6y, 6c, 6m, and 6bk are properly positioned with respect to the frame 33 of the main body 7 of the image forming apparatus 100.

By setting the positioning member 32 to the mounting position with respect to the frame 33 and moving the sliding member 41, the image bearing members 6y, 6c, 6m, and 6bk can be positioned with respect to the main body 7 of the image forming apparatus 100. Moreover, each size of the mounting holes 37y, 37c, 37m, and 37bk formed on the positioning member 32 can be made larger than a cross sectional area at the near side end of each of The supporting members 15y, 15c, 15m, and 15bk. Thereby, the supporting members 15y, 15c, 15m, and 15bk can easily be fitted into the mounting holes 37y, 37c, 37m, and 37bk.

As described above, the image forming apparatus 100 of the example embodiment includes the pressing members 44y, 44c, 44m, and 44bk that respectively press supporting members 15y, 15c, 15m, and 15bk fitted into the mounting holes 37y, 37c, 37m, and 37bk to the vertical planes 45y, 45c, 45m, and 45bk and the horizontal planes 46y, 46c, 46m, and 46bk, respectively. The pressing members 44y, 44c, 44m, and 44bk have the respective V-shaped portions 53y, 53c, 53m, and 53bk that are pushed toward a position between the guide surface 50 and the supporting members 15y, 15c, 15m, and 15bk so as to press the supporting members 15y, 15c, 15m, and 15bk.

When the sliding member 41 is at the first position, the pressing members 44y, 44c, 44m, and 44bk respectively biased by the tension springs 52y, 52c, 52m, and 52bk are regulated by the stoppers 49y, 49c, 49m, and 49bk mounted on the sliding member 41 so as to stay away from the supporting members 15y, 15c, 15m, and 15bk without contacting the supporting members 15y, 15c, 15m, and 15bk.

When the sliding member 41 starts to leave from the first position for the second position, the pressing members 44y, 44c, 44m, and 44bk under the above-described condition start to move together with the sliding member 41.

When the sliding member 41 reaches the third position between the first position and the second position, the respective V-shaped portions 53y, 53c, 53m, and 53bk of the biased pressing members 44y, 44c, 44m, and 44bk are pushed to a position between the guide surface 50 and the supporting members 15y, 15c, 15m, and 15bk, and then stop.

When the sliding member 41 further moves toward the second position, the pressing members 44y, 44c, 44m, and 44bk are released from the force exerted by the stoppers 49y, 49c, 49m, and 49bk.

Thus, the sliding member 41, the pressing members 44y, 44c, 44m, and 44bk, the tension springs 52y, 52c, 52m, and 52bk, and the stoppers 49y, 49c, 49m, and 49bk are positioned.

When the sliding member 14 reaches to the second position as shown in FIG. 5, respective V-shaped portions 53y, 53c, 53m, and 53bk of the biased pressing members 44y, 44c, 44m, and 44bk are pushed to a position between the guide surface 50 and the respective circumferential surfaces of the bearings 17y, 17c, 17m, and 17bk. With the frictional force, the sliding member 41 can be held at the second position to properly position the image bearing members 6y, 6c, 6m, and 6bk. When the operator manually slides the sliding member 41 to the first position as shown in FIG. 4, the pressing members 44y, 44c, 44m, and 44bk may leave from the respective circumferential surfaces of the bearings 17y, 17c, 17m, and 17bk. Thereby, the positioning member 32 can be rotated to the open position as shown in FIG. 3.

Further, the vertical planes 45y, 45c, 45m, and 45bk and the horizontal planes 46y, 46c, 46m, and 46bk are mounted on the respective mounting holes 37y, 37c, 37m, and 37bk and are pressed by the supporting members 15y, 15c, 15m, and 15bk are formed substantially perpendicular to each other. Therefore, the supporting members 15y, 15c, 15m, and 15bk can be held in a stable manner to be properly positioned.

Further, the V-shaped portions 53y, 53c, 53m, and 53bk of the pressing members 44y, 44c, 44m, and 44bk have respective angles as represented by “θ”.

For example, as shown in FIG. 7, the V-shaped portion 53bk has the angle “θ”.

When the angle “θ” is too great, the respective V-shaped portion 53bk may be pushed with a large force to the position between the guide surface 50 and the bearing 17bk (not shown in FIG. 7), which can degrade operability of the image forming apparatus 100. Conversely, when the angle “θ” is too small, the operation stroke of the pressing member 44y, 44bk may increase, which may also degrade the operability. Accordingly, for example, the angle “θ” can be set to a range from about 5 degrees to about 45 degrees. As a more specific example, the angle θ is set to a range from about 15 degrees to about 20 degrees.

Further, the respective two planes, that are the respective vertical planes 45y, 45c, 45m, and 45bk and the respective horizontal planes 46y, 46c, 46m, and 46bk, of the mounting holes 37y, 37c, 37m, and 37bk formed on the positioning member 32 are formed to have tongue-shaped pieces 55 and 56, including tongue-shaped pieces 55y, 55m, 56y, and 56m, which are shaped using a cutting and raising process in a press molding. For example, as shown in FIG. 7, the vertical planes 45m and 45bk and the horizontal planes 46m and 46bk of the respective mounting holes 37m and 37bk have respective tongue-shaped pieces 55m and 55bk, and 56m and 56bk. Thereby, round portions 57m and 57bk in FIG. 7 are formed at the base of each of the tongue-shaped pieces 55m, 55bk, 56m, and 56bk. With the above-described structure, when the positioning member 32 is rotated to the closed position as shown in FIG. 2, the bearing 17y may slidably contact with the round portion 57y, which can protect (if not completely prevent) the bearing 17y from being damaged.

Similarly to the above-described structure of the two planes of the mounting holes 37y, 37c, 37m, and 37bk, a plane of each of the pressing members 44y, 44c, 44m, and 44bk contacting the supporting members 15y, 15c, 15m, and 15bk is formed to have a tongue-shaped piece 58 that is shaped using the cutting and raising process in a press molding, thereby forming a round portion 60y at the base of the tongue-shaped piece 58y as shown in FIG. 2. With the above-described structure, when the pressing members 44y, 44c, 44m, and 44bk contact the bearings 17y, 17c, 17m, and 17bk of the respective supporting members 15y, 15c, 15m, and 15bk, the bearings 17y, 17c, 17m, and 17bk can be protected (if not completely prevented) from being damaged.

As described above, the image forming apparatus 100 includes the plurality of image bearing members 6y, 6c, 6m, and 6bk, and the respective supporting members 15y, 15c, 15m, and 15bk. The plurality of pressing members 44y, 44c, 44m, and 44bk pressing the respective supporting members 15y, 15c, 15m, and 15bk are movably supported by the sliding member 41. Therefore, moving the sliding member 41 can move the entire pressing members 44y, 44c, 44m, and 44bk, which can press the respective supporting members 15y, 15c, 15m, and 15bk to the two planes of the respective mounting holes 37y, 37c, 37m, and 37bk.

Further, in the image forming apparatus 100, the image bearing members 6y, 6c, 6m, and 6bk are fixedly supported to the supporting shafts 16y, 16c, 16m, and 16bk of the supporting members 15y, 15c, 15m, and 15bk, respectively. By rotating the supporting shafts 16y, 16c, 16m, and 16bk of the respective supporting members 15y, 15c, 15m, and 15bk, the image bearing members 6y, 6c, 6m, and 6bk are rotated. To perform this operation, the bearings 17y, 17c, 17m, and 17bk are mounted on the front side portion of the respective supporting shafts 16y, 16c, 16m, and 16bk of the respective supporting members 15y, 15c, 15m, and 15bk, so that the bearings 17y, 17c, 17m, and 17bk can be fitted into the mounting holes 37y, 37c, 37m, and 37bk.

As an alternative, the image bearing members 6y, 6c, 6m, and 6bk can be rotatably supported to the supporting shafts 16y, 16c, 16m, and 16bk of the supporting members 15y, 15c, 15m, and 15bk, respectively. In this case, when the image bearing members 6y, 6c, 6m, and 6bk are driven to rotate without rotating the supporting shafts 16y, 16c, 16m, and 16bk of the respective supporting members 15y, 15c, 15m, and 15bk, the supporting shafts 16y, 16c, 16m, and 16bk can be directly fitted into the mounting holes 37y, 37c, 37m, and 37bk. Accordingly, in this case, the respective supporting members 15y, 15c, 15m, and 15bk do not have the bearings 17y, 17c, 17m, and 17bk to be fitted into the mounting holes 37y, 37c, 37m, and 37bk.

Further, in the image forming apparatus 100, the supporting shafts 16y, 16c, 16m, and 16bk are integrally mounted to the image bearing members 6y, 6c, 6m, and 6bk, respectively. However, as an alternative, a supporting shaft can be rotatably or non-rotatably mounted to a frame of a main body of an image forming apparatus so as to detachably mount an image bearing member in an axial direction of the supporting shaft. The above-described structure can be employed in such image forming apparatus.

Further, when the supporting shaft is rotatably mounted to the frame, the image bearing member supporting member may include the supporting shaft and a bearing mounted at the near side portion of the supporting shaft. When the supporting shaft is non-rotatably mounted to the frame, the supporting shaft may directly be fitted into a mounting hole of a positioning member.

The above-described structures according to one or more embodiments of the present invention can be applied to an image forming apparatus that includes on image bearing member.

The above-described example embodiments are illustrative, and numerous additional modifications and variations are possible in light of the above teachings. For example, elements and/or features of different illustrative and example embodiments herein may be combined with each other and/or substituted for each other within the scope of this disclosure and appended claims. It is therefore to be understood that within the scope of the appended claims, the disclosure of this patent specification may be practiced otherwise than as specifically described herein.

With some example embodiments of the present invention having thus been described, it will be obvious that the same may be varied in many ways. Such variations are not to be regarded as a departure from the spirit and scope of the present invention, and all such modifications are intended to be included within the scope of the present invention.

What is claimed is:

1. An image forming apparatus, comprising:
an image bearing member configured to bear an image on a surface thereof;
a supporting member configured to support the image bearing member;
a sliding member having a guide portion;
a positioning member configured to be detachably positioned at a given position on the sliding member, the positioning member including a fitting portion having planes and configured to fit with the supporting member while the positioning member being positioned at the given position; and
a pressing member configured to press the image bearing member supporting member toward the planes of the fitting portion, the pressing member having a V-shaped portion so that the V-shaped portion is pushed between the guide portion and the supporting member to press the supporting member.

2. The image forming apparatus according to claim 1, wherein:
the sliding member is configured to move between first and second positions and further includes a regulating member mounted thereon configured to regulate movement of the pressing member, and
the pressing member is movably supported by the positioning member while being biased by a spring, both ends of which are locked by the sliding member and the pressing member.

3. The image forming apparatus according to claim 2, wherein respective positions of the sliding member, the pressing member, the spring, and the regulating member are determined such that:
when the sliding member is located at the first position, the pressing member biased by the spring is regulated by the regulating member to stay away from the image bearing member supporting member;
when the sliding member leaves from the first position for the second position, the pressing member moves together with the sliding member;
when the sliding member comes to a third position located between the first and the second positions, the V-shaped portion is pushed to a position between the guide portion and the image bearing member supporting member, and then is stopped; and
when the sliding member further moves toward the second position, the pressing member is released from a force exerted by the regulating member.

4. The image forming apparatus according to claim 1, wherein:
the planes are disposed substantially perpendicular to each other.

5. The image forming apparatus according to claim 1, wherein:
the V-shaped portion of the pressing member has an angle between about 5 degrees and about 45 degrees.

6. The image forming apparatus according to claim 5, wherein:
the V-shaped portion of the pressing member has an angle between about 15 degrees and about 20 degrees.

7. The image forming apparatus according to claim 1, wherein:
the planes of the fitting portion are formed by respective tongue-shaped pieces produced by using a cutting and raising process.

8. The image forming apparatus according to claim 1, wherein:
a portion of the pressing member contacting with the image bearing member supporting member is formed by a tongue-shaped piece produced by using a cutting and raising process.

9. The image forming apparatus according to claim 3, wherein the apparatus includes:
plural instances of the image bearing member, plural instances of the supporting member configured to support the plural instances of the image bearing member, respectively, and plural instances of the pressing member configured to press the respective plural instances of the supporting member; and
wherein the plural instances of the pressing member are movably disposed on the sliding member.

10. An image forming apparatus, comprising:
bearing means for bearing an image on a surface thereof;
supporting means for supporting the bearing means;
moving means for moving having a guide portion;
positioning means for positioning the supporting means, the positioning means including fitting means for fitting having planes and that is fitted with the supporting means while the positioning means is positioned at a given position; and
pressing means for pressing the supporting means toward the planes of the fitting means, the pressing means having a V-shaped portion so that the V-shaped portion is pushed between the guide portion and the supporting means to press the supporting means.

11. The image forming apparatus according to claim 10, wherein:
the moving means moves between first and second positions and further includes regulating means for regulating a movement of the pressing means, and
the pressing means is movably supported by the positioning means while being biased by a spring, ends of which are locked by the moving means and the pressing means.

12. The image forming apparatus according to claim 11, wherein respective positions of the moving means, the pressing means, the spring, and the regulating means are determined such that:
when the moving means is located at the first position, the spring-biased pressing means is regulated by the regulating means to stay away from the supporting means;
when the moving means leaves from the first position for the second position, the pressing means moves together with the moving means;
when the moving means comes to a third portion located between the first and the second positions, the V-shaped portion is pushed to a position between the guide portion and the supporting means, and then is stopped; and
when the moving means further moves toward the second position, the pressing means is released from a force exerted by the regulating means.

13. The image forming apparatus according to claim 10, wherein:
the planes are disposed substantially perpendicular to each other.

14. The image forming apparatus according to claim 12, wherein:
the pressing means is movably disposed on the moving means.

15. A method of positioning an image bearing member supporting member, comprising the steps of:
mounting the image bearing member supporting member to an image forming apparatus;
closing a cover of the image forming apparatus to fit the image bearing member supporting member into a fitting hole formed on a positioning member mounted with respect to the cover;
moving a sliding member in a given direction;
contacting a pressing member mounted on the sliding member with the image bearing member supporting member;
moving the sliding member to a given position;
pushing a V-shaped portion of the pressing member between a guide portion of the sliding member and the image bearing member supporting member to press the image bearing member supporting member; and
engaging the image bearing member supporting member with the positioning member.

16. The method according to claim 15, further comprising the step of:
regulating a movement of the pressing member; and
supporting the pressing member by a spring, both ends of which are locked by the sliding member and the pressing member.

17. The method according to claim 16, wherein respective positions of the sliding member, the pressing member, the spring, and the regulating member are determined such that:
when the sliding member is located at the first position, the pressing member biased by the spring is regulated by the regulating member to stay away from the image bearing member supporting member;
when the sliding member leaves from the first position for the second position, the pressing member moves together with the sliding member;
when the sliding member comes to a third position located between the first and the second positions, the V-shaped portion is pushed to a position between the guide portion and the image bearing member supporting member, and the is stopped; and
when the sliding member further moves toward the second position, the pressing member is released from a force exerted by the regulating member.

18. The method according to claim 16, further comprising the step of:
forming respective tongue-shaped pieces produced by using a cutting and raising process for planes of the fitting hole and a portion of the pressing member which contacts with the image bearing member supporting member.
